(19) United States
(12) Patent Application Publication
(10) Pub. No.: US 2003/0029922 A1
(43) Pub. Date: Feb. 13, 2003

(54) Currency certificate

(76) Inventor: Charles Austin, Cartersville, GA (US)

Correspondence Address: Myers & Associates, Intellectual Property Law, P.C, Building 3, Suite 200, 1827 Powers Ferry Road, Atlanta, GA, 30339, US

(21) Appl. No.: 09/924,012

(22) Filed: Aug. 7, 2001

(51) Int. Cl. G06K 19/06

(52) U.S. Cl. 235/494

(57) ABSTRACT

A merchandising system and method for using redeemable currency certificates. The currency certificates contain a front surface having located thereon a first serial number, a second serial number, a hologram, an issue policy and an honor policy, and a rear surface having located thereon a business card information display region. The currency certificates also contain a perforated line running perpendicular to a longitudinal plane of the certificate for dividing both the front and rear surfaces into approximately two equal half portions. The currency certificates are approximately the size and shape of a United States of America dollar bill. A bar code and additional pertinent indicia may also be found on the currency certificate. The currency certificates are useful for a varying discount based upon the size of a transaction at participating stores. The merchandising system relies on the use of the currency certificates for attracting customers and for transferring information.

### TECHNICAL FIELD

The present invention relates generally to redeemable coupons, and more particularly, to redeemable currency certificates and to a merchandising system and method for using same.

### BACKGROUND OF THE INVENTION

Coupons or certificates have been the subject of numerous patents in the past. U.S. Pat. No. 1,311,698, issued to N. P. Jesup on Jul. 29, 1919, shows a commercial certificate that comprises a profit-sharing coupon or element, having a predetermined discount on a transaction, and an associable sheet or element adapted to carry portions of the coupon and become a bankable instrumentality. The coupon taught by Jesup comprises a body portion or bank coupon check and a detachable portion that represents a bank coupon or fractional portion of the deposit or savings certificate. Also, provided on the body portion are instructions or directions as to the use and value of the coupons. A means for permitting ready detachment of the bank coupon or a deposit certificate unit from the body portion is also provided; the means provided is a series of lines of perforations extending diagonally between the two portions. On the detachable portion or stub, are designations representing the unit value of the coupon and designations representing a number corresponding to a bank account number. The act of detaching the bank coupon, or deposit certificate, cancels the bank coupon check. More information is printed on the opposite side of the bank coupon or deposit certificate. The information on the opposite side pertains to instructions on redeeming the bank coupon or deposit certificate. The bank coupon or deposit certificate taught by Jesup pertains to profit-sharing coupon and deposit or savings certificate.

U.S. Pat. No. 4,171,864 issued to Jung et al. on Oct. 23, 1979, discloses the use of holographic images for ready detection of counterfeiting, alteration and misuse of documents including checks and certificates plus cards such as driver's licenses and bank cards. Jung et al. teaches an identification document having identical data both in visual and holographic form. The holographic images are invisible to the naked eye and can only be seen when a viewer is utilized.

U.S. Pat. No. 4,634,147 issued to McClure on Jan. 6, 1987, teaches a refund coupon redeemable at a cash value at retail stores when a proof-of-purchase comprising part of a given product's packing packaging is affixed to the coupon. McClure teaches coupon indemnification indicia on the product and location indicia means indicating a location on the coupon for affixation of part of the product's packaging carrying the product identification code. The coupon identification indicia and the location indicia are positioned on the coupon, proximate each other, to facilitate a visual comparison of the coupon identification indicia and the product identification indicia affixed to the coupon. The Universal Product Code (UPC) is typically used as the product identification indicia.

U.S. Pat. No. 5,002,313 issued to Salvatore on Mar. 26, 1991, shows promotional coupons containing several illustrations covered by irreversibly removable concealment layer to be rubbed off by the recipient of the coupon. Each illustration uncovered reveals a hidden redemption value. The coupon cannot be redeemed if more than one of the competing objects is selected. The coupons represent a type of game. The recipient wins the redemption value uncovered.

U.S. Pat. No. 5,267,753 issued to Chock on Dec. 7, 1993, discloses a bank draft that incorporates a hologram as an anti-counterfeit measure. The holograph crosses over the signature portion. Once the bank draft is signed, a permanent change in the holograph is made which makes any further modification of the signature obvious.

U.S. Pat. No. 5,299,835 issued to Sonnenberg on Apr. 5, 1994, describes a promotional note page that includes a detachable portion that is in the form of a business card. The top portion has a letter head, and the detachable portion or bottom portion has the business card.

U.S. Pat. No. 5,308,119 issued to Roshkoff on May 3, 1994, shows a label that is affixed to a container and delivers a foldable document that has two portions. The two portions of the foldable document are a product information label and the other portion has a negotiable instrument. A perforated line separates the two portions. Roshkoff also shows the use of a survey form for information disclosure about the product.

U.S. Pat. No. 5,780,133 issued to Engstrom on Jul. 14, 1998, teaches a variable value retail coupon system having a sheet that is covered to hide coupons and two offers with each coupon. The recipient selects which offer is preferred and tears that side of the coupon off.

U.S. Pat. No. 5,822,735 issued to De Lapa et al. on Oct. 13, 1998, teaches a computerized merchandising system for generating and redeeming product discount coupons and prints coupons for a selected customer. The invention of De Lapa et al. allows a retailer to determine which coupons to send a particular customer based on their purchasing history. An identifying bar code, product name and recipient name and address are included on each coupon.

U.S. Pat. No. 5,844,221 issued to Madigan, Jr. et al. on Dec. 1, 1998, describes a method and system for redeeming one or more coupons having an identifying bar code printed thereon. The bar codes on the products and the coupons are separately scanned, and the amount of the coupon is automatically credited to the recipient's total. The computer verifies that the correct coupon and product are matched.

Therefore, it is readily apparent that there is a need for a redeemable currency certificate, wherein a merchandising system and method provides for a varying discount based upon the size of a transaction at participating stores and further serves to attract new patrons to business establishments utilizing such a merchandising system and method.

### BRIEF SUMMARY OF THE INVENTION

Briefly described, in a preferred embodiment, the present invention overcomes the above-mentioned disadvantages and meets the recognized need for such a device by providing a merchandising system using redeemable coupons referred to herein as currency certificates. The currency certificates are approximately the size and shape of a United States of America dollar bill, and have a distinctive appearance. The currency certificates have several distinguishing characteristics such as a holographic foil, space for business information, and are perforated. A bar code and additional pertinent indicia may be also found on the currency certificate. These currency certificates are used for a varying discount, based upon the size of the transaction and the number of certificates tendered, at participating stores. Additionally, a store's participating number is included on the currency certificate to distinguish the issuing store. The merchandising system relies on the use of the currency certificates for attracting customers and for transferring information.

Accordingly, it is a feature and advantage of the present invention to have a currency certificate intended to be used at participating establishments for discounts, rather than for a particular product or at a particular establishment.

Another feature and advantage of the present invention is to have a currency certificate containing a convenient business card for customers, which has the merchant's address, telephone number and other information conveniently displayed thereon. A merchant can hand out the currency certificate instead of business cards, which gives the recipient greater incentive to keep the merchant's demographics available.

A feature and advantage of the present invention is to have a currency certificate that has two parts, wherein the customer keeps one part or stub, and the merchant keeps the other part, thereby giving the customer the ability to tally his/her savings and the merchant to recognize the effectiveness of the currency certificate.

A feature and advantage of the present invention is to provide a currency certificate that conveniently fits into a billfold. The currency certificate has the same dimensions as a United States of America dollar bill.

A feature and advantage of the present invention is to provide a currency certificate that has a discount based on the size of the transaction, and the number of currency certificates utilized. The discount can range from zero to 20% with a set maximum transaction size.

A feature and advantage of the present invention is to provide improved elements and arrangements thereof in a merchandising system and a method of using redeemable currency certificates for the purposes described which is inexpensive, dependable and fully effective in accomplishing its intended purposes.

A feature and advantage of the present invention is to evaluate the special marketing needs of hometown merchants, hometown businesses and hometown professionals, and to provide a unique system that combines the features of a U.S. American dollar bill, a business card and a coupon with special honor and issue policies that consequently results in a product that has new action and results, acting neither exactly like a dollar bill nor a business card nor as a coupon alone, thereby propelling the entire marketing concept and its method.

These and other objects, features and advantages of the invention will become more apparent to one skilled in the art from the following descriptions and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures in which like reference numerals denote similar structures and refer like elements throughout, and in which:

FIG. 1 is a front view of a currency certificate according to the present invention.

FIG. 2 is a rear view of the currency certificate according to the present invention.

FIG. 3 is a flow chart depicting the original generation and distribution of the currency certificates.

FIG. 4 is a flow chart depicting the circulation of the certificates upon distribution to the customers or clients.

### DETAILED DESCRIPTION OF THE PREFERRED AND ALTERNATE EMBODIMENTS

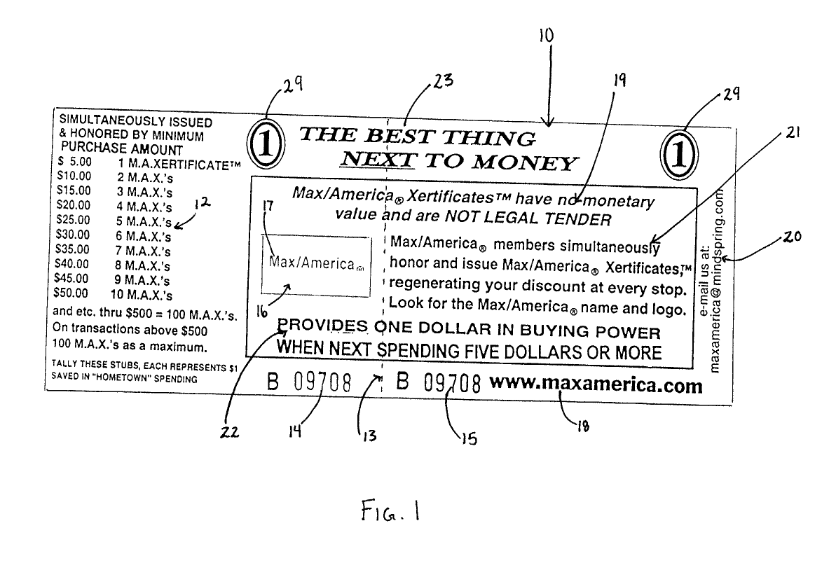

The present invention relates to a merchandising system comprising a redeemable currency certificate and a method for redeeming the currency certificate. FIG. 1 shows the front view or side 10 of the currency certificate. The currency certificate is bisected approximately down the middle by a perforated line 13 that runs perpendicular to the longitudinal plane of the certificate, thereby dividing both the front surface and the rear surface into approximately two equal half portions. On one side of the perforated line 13, as shown in FIG. 1, are identification features such as a hologram 16 and indicia such as an issue and honor schedule policy 12, a first serial number 14, and a currency certificate value indicator 29 that can be printed, stamped, embossed or otherwise provided thereon. The portion of the certificate on the other side of the perforated line 13, as shown in FIG. 1, contains additional identification and informative features such as a first notice 21, a web page reference 18, a second serial number 15, an email address 20, and a currency certificate value indicator 29 corresponding to the value indicator 29 on the opposite side of the perforated line 13. The first serial number 14 and the second serial number 15 have the same series of letters and numbers or other identifying features that are used to track the currency certificates issued. Overlapping the perforated line 13 are a first banner 23, a second notice 19, and a second banner 22, as shown in FIG. 1.

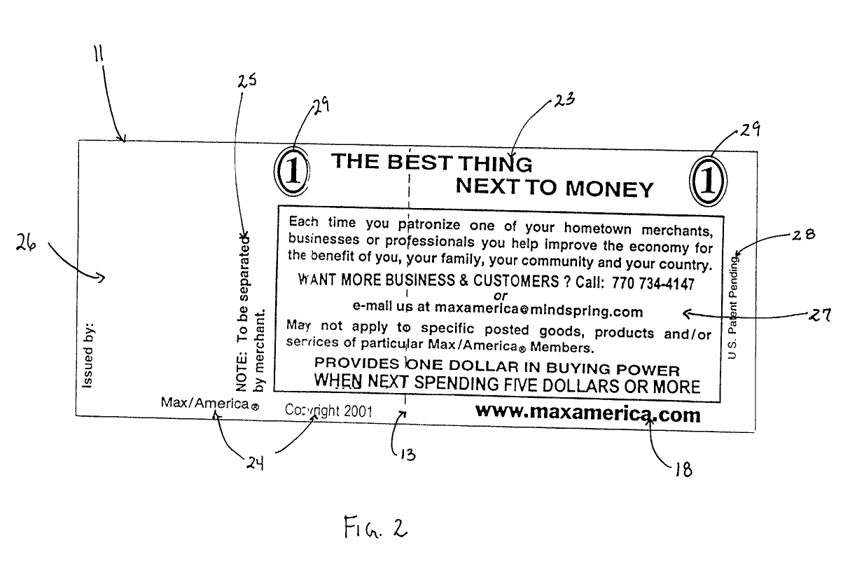

FIG. 2 shows the rear side 11 or view of the currency certificate. Like the front side 10 shown in FIG. 1, the rear side 11 of the currency certificate is bisected approximately down the middle by the perforated line 13 that runs perpendicular to the longitudinal plane of the certificate, thereby dividing the certificate into approximately two equal half portions. On one side of the perforated line 13 are additional identification indicia printed, stamped, embossed or otherwise provided thereon, such as a business card 26 information display area or region, a third notice 25, a fourth notice 24, and a currency certificate value indicator 29 corresponding to the value indicator 29 shown in FIG. 1. The business card 26 area can be left blank for receiving the appropriate printed or stamped business information. On the other side of the perforated line 13, on the rear side 11 of the currency certificates, is the web page reference 18. Overlapping the perforated line 13 is the first banner 23, which is the same as on the front view 10. There is also a fifth notice 27, a sixth notice 28, and a currency certificate value indicator 29 corresponding to the value indicator 29 shown in FIG. 1.

Alternatively, a bar code (not shown) and/or additional pertinent indicia can be added to the currency certificate for identification reasons. Also, a holographic design 17 can be added to the holograph 16.

Preferably, the currency certificate has the same dimensions as a United States of America legal tender paper currency, and can be easily carried in a typical wallet, billfold purse. The currency certificate has a substantially rectangular shape having dimensions of approximately 2 10/16 inches by approximately 6⅛ inches. The currency certificates will be honored anywhere a merchant, business or profession exists as a member 32 of the certificate issuer 31, Max/America(R). Thus, the currency certificates can be utilized at a large variety of businesses in a manner analogous to regular money. The business card display area 26 aspect permits essential business elements to be placed on the currency certificate, e.g., the name of a member 32 business, street address, city and state, zip code, telephone number, FAX number, an e-mail address and the like can be placed thereon. The business card display area 26 can be stamped or printed with the appropriate business card information using a printer or any other printing means.

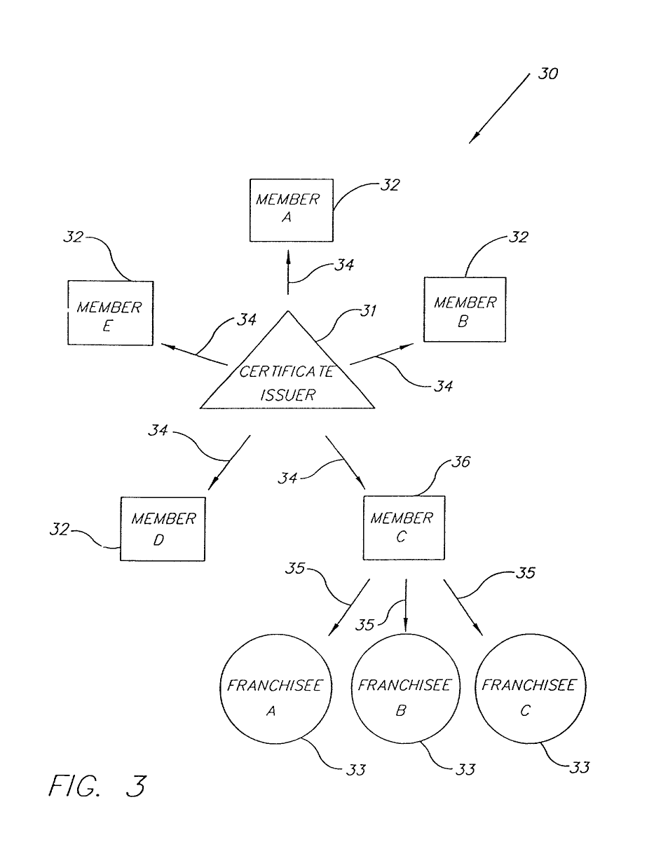

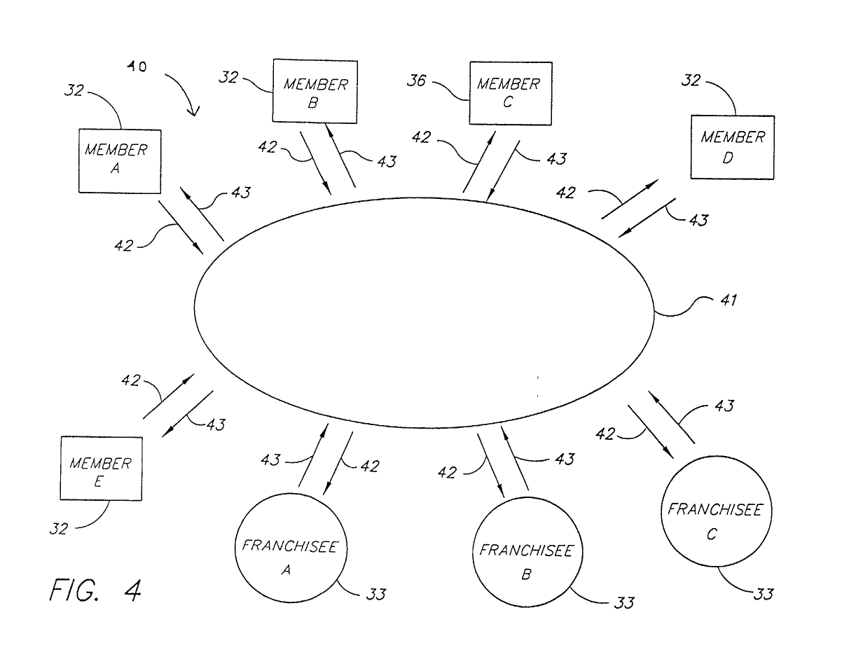

The preferred method for redeeming the currency certificate is depicted in FIGS. 3 and 4. FIG. 3 shows the issuance flow chart 30 depicting the original distribution of the currency certificate after production of the currency certificates. The currency certificate is manufactured conventionally and preferably sold by a central facility referred to as the certificate issuer 31. The certificate issuer 31 makes the currency certificate preferably as substantially shown in FIGS. 1 and 2. The business card display area 26 aspect may not be printed or stamped at the time of issuance but may be left blank. The certificate issuer 31 delivers blank currency certificates to members 32 and franchise members 36 at the time of initial issuance 34. Members 32 include any type of businessmen such as merchants or service professionals. Franchise members 36 are franchisers, representatives, sales agents or subcontractors and are the same as other members 32 except that the franchise members 36 make subsequent issuance 35 of the currency certificates to their franchisees 33. The certificate issuer 31 treats the franchise members 36 and the members 32 identically.

The currency certificates are sold to members 32 or franchise members 36 according to their sales volume in sufficient quantity that they can be distributed to their customers or clients in the normal course of business at the rate of one certificate per every five dollars spent. The currency certificates are stamped or printed with the essential elements contained on the member's business card, preferably by the member 32, franchise member 36, or franchise 33, thereby replacing the member's business card so that the currency certificates become auxiliary business cards, and worth one dollar in buying power when spending five dollars or more.

The business card 26 aspect is stamped or printed at the member's 32 discretion after initial issuance 34. The franchise members 36 can either stamp or print their business information on the business card 26 aspect before or after their subsequent issuance 35 to the franchisees 33 whereupon the franchisees 33 stamp or print the business information on the business card 26 aspect.

Although the currency certificates provide an immediate incentive for the customer to be a repeat customer and spend five dollars or more, the currency certificates are also universally reciprocating. FIG. 4 shows the distribution and redemption flow chart 40 for the currency certificates when placed in circulation 41. The currency certificates are useable at any member's 32 or franchise member's 36 business establishment regardless of which member 32 or franchise member 36 initially distributed 43 the currency certificates to their customers or clients. The currency certificates are honored on the exact same schedule regardless of where presented 42 by customers or clients. The currency certificates are distributed 43 in the normal course of business with customers or clients, even when a transaction is being conducted where previously distributed 43 currency certificates are being honored. When a currency certificate is presented 42 by a customer or client to a member 32 or franchise member 36, the currency certificate should be torn along the perforated line 13 so that it will not be reused.

Once the currency certificate is torn along the perforated line 13, the businessman redeeming the currency certificate keeps the portion of the currency certificate with the business card 26 aspect and returns the part with the holograph 16 to the customer or client. As such, the customer or client can tally their savings via the total number of MAX/AMERICA stubs. The businessman can encourage their patrons to go to the businesses for which they have the business cards 26 and are MAX/AMERICA members, thus creating a reciprocal referral relationship with other members 32 and franchise members 36. Preferably, a hand directory, yellow page directory and an Internet directory will be provided to facilitate referral relationships.

The currency certificates provide incentive to the public to be loyal customers or clients through a discount that ranges up to 20%. The discount is determined by the size of the transaction being conducted and the number of currency certificates tendered. A set schedule is used to determine the size of the discount. For example, a $100 transaction plus two currency certificates results in a 2% discount. Thus, the patron pays $98 in United States of America currency and two currency certificates. Another example, a $100 transaction plus 20 currency certificates results in a 20% discount. The patron pays $80 plus 20 currency certificates. However, a $100 transaction plus 100 currency certificates results in the maximum 20% discount with the member 32 accepting only 20 of the 100 currency certificates. In consideration of the economic consequences for members 32 who sell big ticket items of over $500, no more than 100 currency certificates are required to be honored or issued on transactions at or above $500.

The issue and honor schedule is an integral aspect of the method of using the currency certificate. A cash value of five dollars or more must be owed the merchant before the currency certificates can be used.

Having thus described exemplary embodiments of the present invention, it should be noted by those skilled in the art that the present disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A detachable redeemable currency certificate, comprising:
a front surface having imprinted thereon indicia representing a first serial number, a second serial number, a hologram, an issue policy and an honor policy;
a rear surface having located thereon a business card information display region; and
a line of perforations running perpendicular to a longitudinal plane of said currency certificate for dividing both the front surface and the rear surface into approximately two equal half portions.

2. The detachable redeemable currency certificate of claim 1, wherein said front surface and said rear surface comprise a bar code and additional information.

3. The detachable redeemable currency certificate of claim 1, wherein said first serial number and said second serial number have the same series of numbers and letters for identifying and tracking said currency certificates.

4. The detachable redeemable currency certificate of claim 1, wherein said first serial number and said second serial number are located on opposite sides of said line of perforations

5. The detachable redeemable currency certificate of claim 1, wherein said hologram, said issue policy and said honor policy are located on the same half portion formed by said line of perforations.

6. The detachable redeemable currency certificate of claim 1, wherein said second serial number and said business card information display region are located on the same half portion formed by said line of perforations.

7. The detachable redeemable currency certificate of claim 1, wherein said first serial number and said business card information display region are located on the same half portion formed by said line of perforations.

8. The detachable redeemable currency certificate of claim 1, further comprising indicia representing a first banner, a second banner and a notification feature imprinted on said front surface, wherein said first banner, said second banner and said notification feature are each partially located on the two half portions of said currency certificate formed by said line of perforations.

9. The detachable redeemable currency certificate of claim 1, wherein said currency certificate has a substantially rectangular shape.

10. A detachable redeemable currency certificate, comprising:
a front surface having imprinted thereon indicia representing at least a first serial number;
a rear surface having located thereon a business card information display region; and
a line of perforations running perpendicular to a longitudinal plane of said currency certificate for dividing both the front surface and the rear surface into approximately two equal half portions.

11. The detachable redeemable currency certificate of claim 10, further comprising a currency certificate value indicator, said currency certificate value indicator corresponding to the value of said currency certificate.

12. The detachable redeemable currency certificate of claim 10, further comprising a web page reference.

13. The detachable redeemable currency certificate of claim 10, further comprising a hologram having a holographic design.

14. The detachable redeemable currency certificate of claim 10, wherein said indicia further comprises an issue policy and an honor policy.

15. A method for redeeming a currency certificate, comprising the steps of:
a. a currency certificate issuer issuing a currency certificate to at least one of a plurality of members participating in said redemption of said currency certificates;
b. providing means for affixing a business card onto said currency certificate by said at least one of a plurality of members;
c. distributing said currency certificates to a patron by said at least one of a plurality of members whose card is affixed thereon;
d. presenting said currency certificate to a said at least one of a plurality of members by said patron; and
e. redeeming said currency certificate by said at least one of a plurality of members to whom said currency certificate was presented by said patron.

16. The method for redeeming a currency certificate of claim 15, wherein said at least one of a plurality of members is a franchise member and further comprising the step of issuing said currency certificate to a franchisee for subsequent issuance and redemption by said patron.

17. The method for redeeming a currency certificate of claim 15, wherein said means of affixing said business card to said currency certificate by said one of a plurality of members is stamping, printing, embossing, appending, gluing or taping.

18. The method for redeeming a currency certificate of claim 15, further comprising the step of determining the amount of said redemption of said currency certificate in proportion to the size of the transaction and the number of said currency certificates presented by said patron to said one of a plurality of members.

19. The method for redeeming a currency certificate of claim 15, further comprising the step of having, upon presentation of said currency certificate by a patron to said at least one of a plurality of members, said at least one of a plurality of members tear said currency certificate along a provided perforated line to prevent reuse of said currency certificate.

20. The method for redeeming a currency certificate of claim 19, further comprising the steps of having said at least one of a plurality of members retain the one-half portion of the torn said currency certificate that contains said business card affixed thereon and returning the other one-half portion of the torn said currency certificate to said patron from whom the certificate came.

21. The method for redeeming a currency certificate of claim 20, further comprising the step of having said at least one of a plurality of members refer and encourage said patron to visit the business indicated on said business card affixed to said one-half portion of the torn said currency certificate.

22. The method for redeeming a currency certificate of claim 15, further comprising the step of setting a maximum redeemable amount/discount of 20 percent of 500 dollars.

23. The method for redeeming a currency certificate of claim 22, wherein said amount/discount is determined by the size of the transaction being conducted and the number of currency certificates tendered.

24. The method for redeeming a currency certificate of claim 15, wherein a cash value of 5 dollars or more must be owed to said one of a plurality of members before said currency certificates can be used by said patron.

25. The method for redeeming a currency certificate of claim 15, wherein said currency certificates are redeemable at any of said at least one of a plurality of members.
